(19) United States
(12) Patent Application Publication
(10) Pub. No.: US 2024/0251278 A1
(43) Pub. Date: Jul. 25, 2024

(54) METHOD AND APPARATUS FOR COLLECTING SENSING DATA, AND CORE NETWORK ELEMENT

(71) Applicant: GUANGDONG OPPO MOBILE TELECOMMUNICATIONS CORP., LTD., Dongguan (CN)

(72) Inventor: Yali Guo, Dongguan (CN)

(21) Appl. No.: 18/625,885

(22) Filed: Apr. 3, 2024

Related U.S. Application Data
(63) Continuation of application No. PCT/CN2021/123145, filed on Oct. 11, 2021.

(51) Int. Cl. H04W 24/10; H04L 67/12; H04W 48/14

(52) U.S. Cl. CPC H04W 24/10; H04L 67/12; H04W 48/14

(57) ABSTRACT

A method and apparatus for collecting sensing data, and a core network element are provided. The method includes the following. An access-network device and/or a terminal device receives information of a second core network element provided by a first core network element. The access-network device and/or the terminal device reports sensing data to the second core network element according to the information of the second core network element.

### CROSS-REFERENCE TO RELATED APPLICATION

This application is a continuation of International Application No. PCT/CN2021/123145, filed Oct. 11, 2021, the entire disclosure of which is incorporated herein by reference.

### TECHNICAL FIELD

Embodiments of the disclosure relate to the field of communication technology, and more particularly, to a method and apparatus for collecting sensing data, a device, a system, and a storage medium.

### BACKGROUND

A current cellular network is used only for communication, but actually, a radio electromagnetic wave signal used by a cellular network not only can be used for wireless data transmission and communication but also has environment sensing capability, such as user action or gesture recognition, breathing monitoring, terminal moving speed measurement, environment imaging, and weather monitoring.

In addition to communication and data transmission, a future cellular network may also be considered to be used for obtaining sensing data. Therefore, how to collect sensing data is a problem that needs further study.

### SUMMARY

According to an aspect of embodiments of the disclosure, a method for collecting sensing data is provided. The method is performed by an access-network device or a terminal device. The method includes the following. Receive information of a second core network element provided by a first core network element. Report sensing data to the second core network element according to the information of the second core network element.

According to an aspect of embodiments of the disclosure, an apparatus for collecting sensing data is provided. The apparatus is an access-network device or a terminal device. The apparatus includes a transceiver, a memory configured to store computer programs, and a processor coupled to the transceiver and configured to execute the computer programs stored in the memory to cause the transceiver to: receive information of a second core network element provided by a first core network element; and report sensing data to the second core network element according to the information of the second core network element.

According to an aspect of embodiments of the disclosure, a core network element is provided. The core network element includes a transceiver, a memory configured to store computer programs, and a processor coupled to the transceiver and configured to execute the computer programs stored in the memory to cause the transceiver to receive sensing data from an access-network device or a terminal device. Where the sensing data is sent by the access-network device or the terminal device according to information of the core network element provided by a first core network element.

### BRIEF DESCRIPTION OF THE DRAWINGS

FIG. 1 is a schematic diagram of a network architecture provided in an embodiment of the disclosure.

FIG. 2 is an architectural diagram of a 5^{th} generation system (5GS) provided in an embodiment of the disclosure.

FIG. 3 is an architectural diagram of a 5GS provided in another embodiment of the disclosure.

FIG. 4 is a schematic diagram of a system for collecting sensing data provided in an embodiment of the disclosure.

FIG. 5 is a flowchart of a method for collecting sensing data provided in an embodiment of the disclosure.

FIG. 6 is a flowchart of a method for collecting sensing data provided in another embodiment of the disclosure.

FIG. 7 is a flowchart of a method for collecting sensing data provided in another embodiment of the disclosure.

FIG. 8 is a flowchart of a method for collecting sensing data provided in another embodiment of the disclosure.

FIG. 9 is a block diagram of an apparatus for collecting sensing data provided in an embodiment of the disclosure.

FIG. 10 is a block diagram of an apparatus for collecting sensing data provided in another embodiment of the disclosure.

FIG. 11 is a block diagram of an apparatus for collecting sensing data provided in another embodiment of the disclosure.

FIG. 12 is a block diagram of an apparatus for collecting sensing data provided in another embodiment of the disclosure.

FIG. 13 is a schematic structural diagram of a device provided in an embodiment of the disclosure.

### DETAILED DESCRIPTION

In order to make the objectives, technical solutions, and advantages of the disclosure clearer, implementations of the disclosure will be described in further detail below with reference to the accompanying drawings.

The network architecture and service scenario described in embodiments of the disclosure are intended to describe the technical solutions of the embodiments of the disclosure more clearly, and do not constitute limitation on the technical solutions provided in the embodiments of the disclosure. Those of ordinary skill in the art can appreciate that, with evolution of network architectures and emergence of new service scenarios, for similar technical problems, the technical solutions provided in the embodiments of the disclosure are also applicable.

Technical solutions of embodiments of the disclosure may be applied to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 5^{th}-generation (5G) communication system, or other communication systems.

Generally speaking, a conventional communication system generally supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, or vehicle to everything (V2X) communication, etc. Embodiments of the disclosure can also be applied to these communication systems.

The communication system in embodiments of the disclosure may be applied to a carrier aggregation (CA) scenario, or may be applied to a dual connectivity (DC) scenario, or may be applied to a standalone (SA) network deployment scenario.

The communication system in embodiments of the disclosure is applicable to an unlicensed spectrum, and an unlicensed spectrum may be regarded as a shared spectrum. Alternatively, the communication system in embodiments of the disclosure is applicable to a licensed spectrum, and a licensed spectrum may be regarded as a non-shared spectrum.

The embodiments of the disclosure may be applied to an NTN system, or may be applied to a terrestrial network (TN) system.

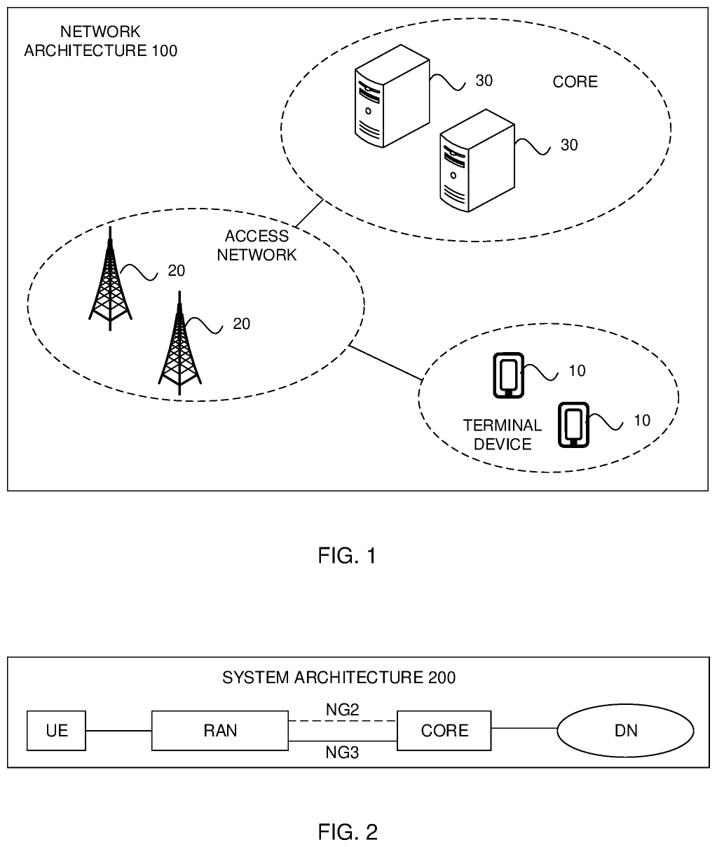

Referring to FIG. 1, FIG. 1 is a schematic diagram of a network architecture 100 provided in an embodiment of the disclosure. The network architecture 100 may include a terminal device 10, an access-network device 20, and a core network element 30.

The terminal device 10 may refer to a user equipment (UE), an access terminal, a subscriber unit, a subscriber station, a mobile station, a remote station, a remote terminal, a mobile device, a wireless communication device, a user agent, or a user device. Optionally, the terminal device 10 may also be a cellular telephone, a cordless telephone, an session initiation protocol (SIP) telephone, a wireless local loop (WLL) station, a personal digital assistant (PDA), various devices having wireless communication functions such as a handheld device, a computing device, or other processing devices connected to a wireless modem, an in-vehicle device, or a wearable device, a terminal device in a 5G system (5GS) or a terminal device in a future evolved public land mobile network (PLMN), etc., and embodiments of the disclosure are not limited in this regard. For the convenience of illustration, the foregoing devices are collectively referred to as “terminal device”. The quantity of terminal devices 10 is generally multiple, and there may be one or more terminal devices 10 distributed in a cell managed by each access-network device 20. In embodiments of the disclosure, the terms “terminal device” and “UE” are usually used interchangeably, but the meaning thereof can be understood by those skilled in the art.

The access-network device 20 is a device deployed in an access network to provide wireless communication functions for the terminal device 10. The access-network device 20 may include various forms of macro base stations, micro base stations, relay stations, access points, etc. The names of a device having functions of the access-network device may be different in systems adopting different radio access technologies, which is, for example, referred to as a gNodeB or a gNB in a 5G NR system. With evolution of communication technology, the name “access-network device” may change. For the convenience of illustration, in embodiments of the disclosure, the foregoing apparatus for providing wireless communication functions for the terminal device 10 is collectively called “access-network device”. Optionally, a communication relationship may be established between the terminal device 10 and the core network element 30 via the access-network device 20. Exemplarily, in an LTE system, the access-network device 20 may be an evolved universal terrestrial radio access network (EUTRAN) or one or more eNodeBs in the EUTRAN. In a 5G NR system, the access-network device 20 may be a RAN or one or more gNBs in the RAN.

The core network element 30 is a network element deployed in a core network (Core). Main functions of the core network element 30 are to provide a user connection, manage a user, complete service carrying, and act as a bearer network to provide an interface to an external network. For example, the core network element in a 5G NR system may include network elements such as an access and mobility management function (AMF), a user plane function (UPF), and a session management function (SMF). In addition, the core network element may be regarded as a functional entity, and one or more core network elements may be deployed for a physical device.

In some embodiments, the access-network device 20 and the core network element 30 communicate with each other with some air interface technology, such as an NG interface in a 5G NR system. The access-network device 20 and the terminal device 10 communicate with each other with sone air interface technology, such as a UE-UTRAN (Uu) interface.

The “5G NR system” in embodiments of the disclosure may also be referred to as “5G system” or “NR system”, but the meaning thereof can be understood by those skilled in the art. The technical solutions described in embodiments of the disclosure may be applied to an LTE system, or may be applied to a 5G NR system, or may be applied to a future evolved system of a 5G NR system, or may be applied to other communication systems such as a narrow band Internet of things (NB-IoT) system, and the disclosure is not limited in this regard.

In embodiments of the disclosure, the access-network device can serve a cell, and the terminal device communicates with the access-network device over a transmission resource (for example, a frequency domain resource, or referred to as spectrum resource) on a carrier used by the cell. The cell may be a cell corresponding to the access-network device (for example, a base station). The cell may belong to a macro base station, or may belong to a base station corresponding to a small cell. The small cell herein may include a metro cell, a micro cell, a pico cell, a femto cell, etc. These small cells are characterized by small coverage and low transmission power and are adapted to provide data transmission service with high-rate.

Referring to FIG. 2, FIG. 2 is a schematic diagram illustrating a system architecture of a 5GS provided in embodiments of the disclosure. As illustrated in FIG. 2, the system architecture 200 may include a UE (i.e. the “terminal device” described above), a (R)AN, a Core, and a data network (DN). The UE, the (R)AN, and the Core are major components constituting the architecture, and they each may logically be divided into a user plane and a control plane, where the control plane is responsible for mobile network management, and the user plane is responsible for service data transmission. In FIG. 2, NG2 reference point is located between a control plane of the (R)AN and a control plane of the Core, NG3 reference point is located between a user plane of the (R)AN and a user plane of the Core, and NG6 reference point is located between the user plane of the Core and the DN.

UE: an entrance for a mobile user to interact with a network. It can provide basic computing capabilities and storage capabilities, display service windows to the user, and receive user operation input. With a next generation (NG) air interface technology, the UE may establish a signal connection and a data connection with the (R)AN, so that control signals and service data can be transmitted to a mobile network.

(R)AN: similar to a base station in a conventional network, and it is deployed close to the UE to provide network access functions for authorized users in a specific area, and can transmit user data by using transmission tunnels of different qualities according to user levels and service requirements, etc. The (R)AN can manage its own resources, utilize the resources properly, provide access services for the UE according to requirements, and forward the control signals and the user data between the UE and the Core.

Core: responsible for maintaining subscription data of a mobile network, managing network elements of the mobile network, and providing functions such as session management, mobility management, policy management, security authentication, etc. for the UE. When the UE is attached, the Core can provide network access authentication for the UE. When the UE has a service request, the Core can allocate network resources to the UE. When the UE moves, the Core can update network resources for the UE. When the UE is idle, the Core can provide a quick recovery mechanism for the UE. When the UE is detached, the Core can release network resources for the UE. When the UE has service data, the Core can provide a data routing function for the UE, for example, forward uplink data to the DN; or receive downlink data of the UE from the DN and then forward the downlink data to the (R)AN, so as to transmit the downlink data to the UE.

DN: a data network for providing business services for users. Generally, a client is located in the UE, and a server is located in the DN. The DN may be a private network, such as a local area network, or an external network not controlled by operators, such as

Internet, or a dedicated network jointly deployed by the operators, for example, for configuring internet protocol (IP) multimedia core network subsystem (IMS) services.

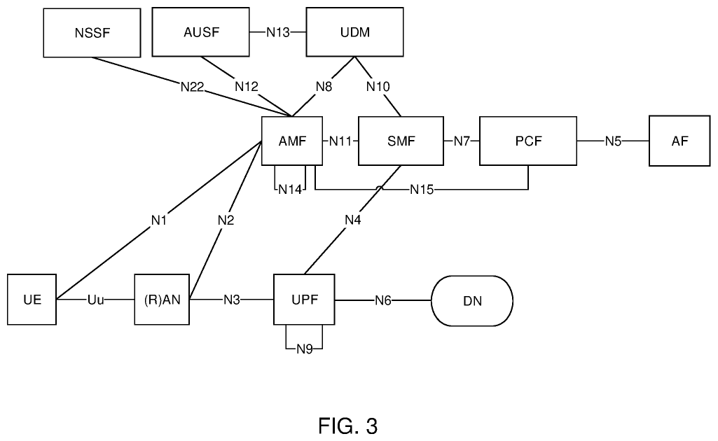

FIG. 3 illustrates a detailed architecture determined based on the architecture illustrated in FIG. 2. The user plane of the Core includes a UPF. The control plane of the

Core includes an authentication server function (AUSF), an AMF, an SMF, a network slice selection function (NSSF), a network exposure function (NEF), a network repository function (NRF), a unified data management (UDM), a policy control function (PCF), and an application function (AF).

In the architecture illustrated in FIG. 3, the UE establishes an access stratum (AS) connection with the (R)AN over a Uu interface in order for AS message interaction and wireless data transmission. The UE establishes a non-access stratum (NAS) connection with the AMF via N1 interface in order for NAS message interaction. The AMF is a mobility management function in the Core. The SMF is a session management function in the Core.

In addition to mobility management of the UE, the AMF is also responsible for forwarding a session management related message between the UE and the SMF. The PCF is a policy management function in the Core, and is responsible for formulating related policies regarding mobility management, session management, charging, etc. of the UE. The UPF is a user plane function in the Core, which performs data transmission with an external DN via N6 interface, and performs data transmission with the (R)AN via N3 interface.

It is to be noted that, the names of interfaces between various network elements in FIG. 2 and FIG. 3 are merely an example, and the interfaces may also be in other names in actual implementations, and embodiments of the disclosure are not limited in this regard.

The names of the network elements (such as SMF, AF, UPF, etc.) in FIG. 2 and FIG. 3 are also merely an example, and do not constitute limitation on the functions of the network elements. In a 5GS and other future networks, the foregoing network elements may also be in other names, and embodiments of the disclosure are not limited in this regard. For example, in a 6^{th} generation (6G) network, some or all of the foregoing network elements may use the terms in 5G, or may use other names, etc., which is collectively explained herein and will not be described again below. In addition, it is to be understood that, the names of messages (or signaling) transmitted between the foregoing network elements are merely an example, and do not constitute any limitation on the functions of the messages.

In a current 3^{rd} generation partnership project (3GPP) network, network capability exposure is implemented by an NEF. For example, a network obtains information such as a location of a UE, and provides the information to a third-party application via the NEF. However, information such as the location of the UE and a connection state of the UE currently exposed to the third-party application is relatively simple with a small amount of data, and can be exposed to the third-party application through control plane signaling. If a future cellular network not only supports communication capability but also supports sensing capability, sensing data may have a large amount of data and cannot be carried in control plane signaling. As a result, the data cannot be exposed to the third-party application even if the cellular network can generate sensing data.

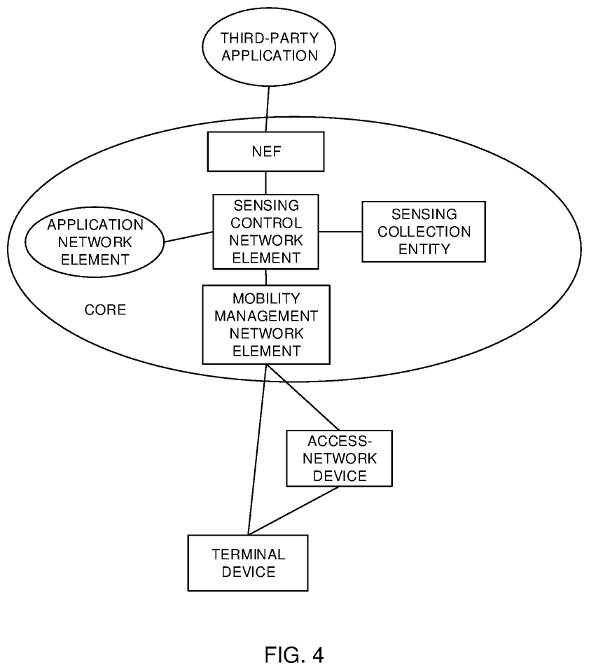

As illustrated in FIG. 4, in an exemplary embodiment of the disclosure, a sensing control network element and a sensing collection entity are added to a Core. The sensing control network element is responsible for control plane message interaction with an AF and control plane message interaction with an internal network element of an operator network. The AF may be an internal application network element of the operator network and interact directly with the sensing control network element, or may be a third-party application external to the operator network and interact with the sensing control network element via an NEF. The sensing collection entity is responsible for collecting sensing data, which includes sensing-related measurement data (such as radio signal measurement data) and a sensing result obtained after calculation or analysis. The sensing collection entity itself may also calculate or analyze the sensing-related measurement data collected, so as to generate a sensing result.

It should be noted that, the sensing control network element may be a new network element in the Core, or may be an existing network element with extended function in the Core, that is, the function of the existing network element is extended such that the existing network element has the functions implemented by the sensing control network element described above. Similarly, the sensing collection entity may be a new network element in the Core, or may be an existing network element with extended function in the Core, that is, the function of the existing network element is extended such that the existing network element has the functions implemented by the sensing collection entity described above. In addition, the sensing control network element may also be referred to as “sensing control function” or “sensing control entity”, or other names, and the disclosure is not limited in this regard. The sensing collection entity may also be referred to as “sensing collection network element”, “sensing collection function”, or other names, and the disclosure is not limited in this regard.

In the following embodiments, a first core network element is a network element responsible for control plane message interaction with an AF and control plane message interaction with an internal network element of an operator network. For example, the first core network element may be the sensing control network element in the architecture illustrated in FIG. 4. A second core network element is a network element responsible for collecting sensing data. For example, the second core network element may be the sensing collection entity in the architecture illustrated in FIG. 4. A third core network element may be a mobility management network element in the system architecture illustrated in FIG. 4, such as an AMF in a 5GS, and is responsible for message forwarding between a terminal device/access-network device and other core network elements in addition to mobility management of the terminal device.

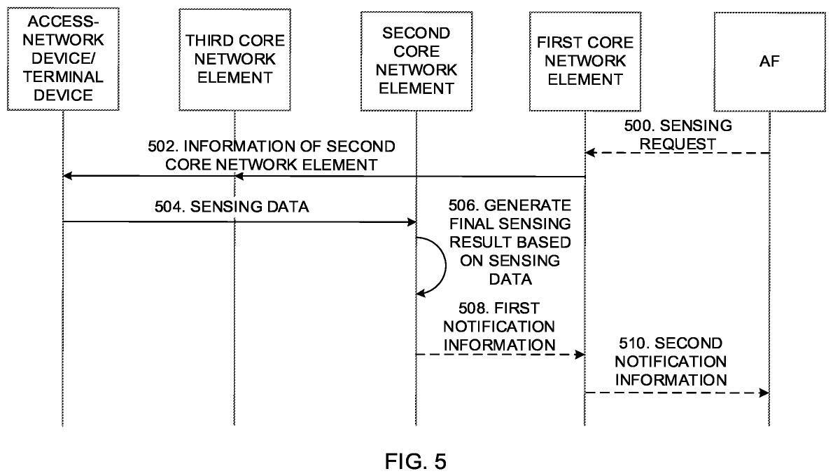

Referring to FIG. 5, FIG. 5 is a flowchart of a method for collecting sensing data provided in an embodiment of the disclosure. The method may be applied to the system architectures illustrated in FIG. 1 to FIG. 4. The method may include at least one of the following steps (502˜510).

Step 502, a first core network element provides information of a second core network element to an access-network device and/or a terminal device, where the second core network element is a network element for collecting sensing data.

In embodiments of the disclosure, by providing the information of the second core network element to the access-network device and/or the terminal device, it is conducive for the access-network device and/or the terminal device to know the second core network element and information related to the second core network element, thereby realizing reporting of sensing data to the second core network element.

Optionally, the information of the second core network element includes at least one of: a network element identity (ID) of the second core network element, an IP address of the second core network element, or domain name information of the second core network element, where the domain name information may be a fully qualified domain name (FQDN), etc.

In some embodiments, the first core network element provides the information of the second core network element to the access-network device and/or the terminal device via a third core network element (such as a mobility management gateway).

For example, the first core network element sends the information of the second core network element to the third core network element, the third core network element provides the information of the second core network element to the access-network device, and then the access-network device reports sensing data to the second core network element according to the information of the second core network element.

For another example, the first core network element sends the information of the second core network element to the third core network element, the third core network element provides the information of the second core network element to the terminal device, and then the terminal device reports sensing data to the second core network element according to the information of the second core network element. In addition, the third core network element may send the information of the second core network element to the terminal device in the following manners. The third core network element sends the information of the second core network element to the terminal device via the access- network device, that is, the third core network element firstly sends the information of the second core network element to the access-network device, and then the access-network device sends the information of the second core network element to the terminal device.

Alternatively, the third core network element sends the information of the second core network element directly to the terminal device.

In some embodiments, the first core network element sends a sensing instruction to the third core network element, where the sensing instruction contains the information of the second core network element. Optionally, the sensing instruction further contains information of the first core network element. Optionally, the information of the first core network element includes at least one of: a network element ID of the first core network element or an association ID of a target sensing task. The association ID of the target sensing task is used for identifying the target sensing task, and different sensing tasks may have different association IDs, thereby realizing differentiation of different sensing tasks. Optionally, the association ID of the target sensing task may be allocated by the first core network element; alternatively, when initiating a sensing request, an AF may carry the association ID of the target sensing task directly in the sensing request, and the disclosure is not limited in this regard.

In some embodiments, as illustrated in FIG. 5, before step 502, the method further includes step 500: the first core network element receives the sensing request sent by the AF, where the sensing request is used for requesting obtaining a final sensing result corresponding to the target sensing task. Then, the first core network element sends a sensing instruction to the third core network element (for the convenience of illustration, the sensing instruction sent to the third core network element by the first core network element is referred to as a first sensing instruction), where the first sensing instruction instructs the third core network element to control the access-network device and/or the terminal device to perform the target sensing task, and the first sensing instruction may contain the information of the second core network element. The third core network element sends a second sensing instruction to the access-network device and/or the terminal device according to the first sensing instruction, where the second sensing instruction indicates that the access-network device and/or the terminal device is to perform a sensing operation related to the target sensing task, and the second sensing instruction may contain the information of the second core network element. Optionally, the first sensing instruction and/or the second sensing instruction further contains the information of the first core network element, such as the network element ID of the first core network element and the association ID of the target sensing task described above.

In addition, if the AF is an internal device of an operator network, the AF may send the sensing request directly to the first core network element. If the AF is an external device of the operator network, the AF may send the sensing request to an NEF, and then the NEF sends the sensing request to the first core network element.

Step 504, the access-network device and/or the terminal device reports sensing data to the second core network element according to the information of the second core network element.

The second core network element collects the sensing data reported by the access-network device and/or the terminal device.

Optionally, after receiving the second sensing instruction, the access-network device and/or the terminal device performs a sensing operation related to the target sensing task according to the second sensing instruction so as to obtain corresponding sensing data, and then reports the obtained sensing data to the second core network element.

Optionally, the sensing data includes at least one of: sensing measurement data or a sensing result, where the sensing measurement data is data used for determining the sensing result. For example, the sensing measurement data may be a measurement value, such as a signal strength and a transmission distance, of a radio electromagnetic wave signal, and the disclosure is not limited in this regard. The access-network device and/or the terminal device may report the sensing measurement data directly to the second core network element, and the second core network element calculates or analyzes the sensing measurement data to obtain a corresponding sensing result. The access-network device and/or the terminal device may also calculate or analyze the sensing measurement data to obtain the corresponding sensing result, and then report the sensing result to the second core network element. Taking weather sensing as an example, a measurement value of a radio electromagnetic wave signal may differ under different weather conditions such as sunny, rainy, etc. Therefore, by calculating or analyzing a measurement value of a radio electromagnetic wave signal of a certain area, it is possible to know a weather condition of the area.

Optionally, the sensing data reported by the access-network device and/or the terminal device further includes the information of the first core network element, such as the network element ID of the first core network element and/or the association ID of the target sensing task, so that the second core network element can know which first core network element initiates sensing that involves the reported sensing data, and know which sensing task is associated with the reported sensing data. For example, after the second core network element collects sensing data from multiple different access-network devices and/or terminal devices, if the association ID of the same target sensing task is carried, the second core network element can know that the sensing data of different sources is associated with the same task, and calculate or analyze the sensing data of different sources to obtain the final sensing result for the target sensing task.

Optionally, the access-network device and/or the terminal device reports the sensing data to the second core network element in a user plane mode (through a user plane) according to the information of the second core network element. Exemplarily, the user plane mode includes sending a data packet carrying the sensing data to the second core network element through the user plane.

Optionally, if the information of the second core network element obtained by the access-network device and/or the terminal device is the network element ID and/or the domain name information of the second core network element, the access-network device and/or the terminal device may parse the information to obtain the IP address of the second core network element, and then report the sensing data to the second core network element based on the IP address of the second core network element. Exemplarily, the access-network device and/or the terminal device may parse the network element ID and/or the domain name information of the second core network element with aid of a domain name system (DNS) resolver, so as to obtain the IP address of the second core network element.

Step 506, the second core network element generates the final sensing result corresponding to the target sensing task based on the sensing data.

The second core network element may generate the final sensing result corresponding to the target sensing task according to collected sensing data related to the target sensing task. For example, the second core network element may calculate or analyze the collected sensing measurement data to generate the final sensing result corresponding to the target sensing task. For another example, the second core network element may generate the final sensing result corresponding to the target sensing task based on sensing data collected from multiple parties (for example, multiple access-network devices and/or terminal devices).

Optionally, as illustrated in FIG. 5, after step 506, the method further includes step 508 to step 510 below.

Step 508, the second core network element sends first notification information to the first core network element, where the first notification information is used for notifying the first core network element that the final sensing result has been generated.

The second core network element may determine the first core network element according to configuration information stored, or may determine the first core network element according to the information of the first core network element in the sensing data.

Optionally, the first notification information includes sensing result exposure information, where the sensing result exposure information is used for obtaining the final sensing result. Optionally, the sensing result exposure information includes at least one of:

an address for obtaining the final sensing result or authorization information for the final sensing result. The address for obtaining the final sensing result may be a uniform resource locator (URL) corresponding to the final sensing result, and the final sensing result may be obtained based on the URL. The authorization information for the final sensing result is used for controlling permission for obtaining the final sensing result. For example, the authorization information may include authorization token information such as an account

ID and a password, or may include information such as authorization time, and as such, the final sensing result can be successfully obtained only by a requester that has received the correct authorization information.

Step 510, the first core network element sends second notification information to the AF, where the second notification information is used for notifying the AF that the final sensing result has been generated, so that the AF obtains the final sensing result according to the second notification information.

If the AF is an internal device of the operator network, the first core network element may send the second notification information directly to the AF. If the AF is an external device of the operator network, the first core network element may send the second notification information to the NEF, and then the NEF sends the second notification information to the AF.

Optionally, the second notification information includes the sensing result exposure information, such as the address for obtaining the final sensing result and the authorization information for the final sensing result described above.

It should be noted that, the sensing result exposure information may be generated by the second core network element or may be generated by the first core network element, or part of the sensing result exposure information is generated by the first core network element and the rest of the sensing result exposure information is generated by the second core network element, and the disclosure is not limited in this regard.

After receiving the second notification information, the AF may obtain the final sensing result corresponding to the target sensing task according to the sensing result exposure information in the second notification information, for example, use the authorization information (such as an account ID and a password) to access the address (such as the URL) for obtaining the final sensing result, so as to obtain the final sensing result. In addition, the final sensing result corresponding to the target sensing task may be stored at the second core network element, or may be stored at other devices, and the disclosure is not limited in this regard.

In the disclosure, information of a core network element for collecting sensing data is provided to the access-network device and/or the terminal device. As such, after obtaining sensing data, the access-network device and/or the terminal device can report successfully to the core network element for collecting sensing data, thereby ensuring reliability and success rate of collecting and reporting sensing data.

In addition, the access-network device and/or the terminal device can report sensing data to a core network element in a user plane mode, which is possible to ensure reliability and success rate of reporting sensing data even if the data amount of sensing data is large.

The technical solutions of the disclosure will be described in detail with reference to several embodiments, in which the first core network element is exemplarily a sensing control network element, the second core network element is exemplarily a sensing collection entity, and the third core network element is exemplarily a mobility management network element. For details not elaborated in the following embodiments illustrated in FIG.

6 to FIG. 8, reference can be made to the elaborations in other embodiments above and below.

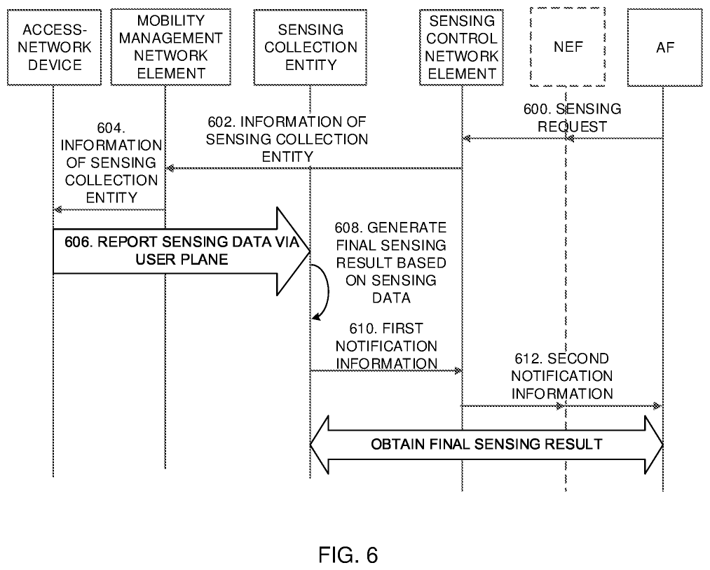

Referring to FIG. 6, FIG. 6 is a flowchart of a method for collecting sensing data provided in another embodiment of the disclosure. The method may be applied to the system architectures illustrated in FIG. 1 to FIG. 4 above. In the embodiments, a sensing control network element provides information of a sensing collection entity to an access-network device, so that the access-network device reports sensing data related to a target sensing task to the sensing collection entity. An AF obtains a final sensing result corresponding to the target sensing task from the sensing collection entity. As illustrated in FIG. 6, the method may include at least one of the following steps (600˜612).

Step 600, a sensing control network element receives a sensing request sent by an AF, where the sensing request is used for requesting obtaining a final sensing result corresponding to a target sensing task.

Step 602, the sensing control network element sends information of a sensing collection entity to a mobility management network element.

Optionally, the sensing control network element sends a first sensing instruction to the mobility management network element, where the first sensing instruction contains the information of the sensing collection entity. For example, the information of the sensing collection entity includes at least one of: a network element ID of the sensing collection entity, an IP address of the sensing collection entity, or domain name information of the sensing collection entity.

Optionally, the first sensing instruction further contains information of the sensing control network element. For example, the information of the sensing control network element includes at least one of: a network element ID of the sensing control network element or an association ID of the target sensing task.

Step 604, the mobility management network element sends the information of the sensing collection entity to an access-network device.

Optionally, the mobility management network element sends a second sensing instruction to the access-network device, where the second sensing instruction contains the information of the sensing collection entity, and optionally further contains the information of the sensing control network element.

Step 606, the access-network device reports sensing data related to the target sensing task to the sensing collection entity according to the information of the sensing collection entity.

Optionally, the sensing data includes at least one of: sensing measurement data or a sensing result. Optionally, the sensing data further includes the information of the sensing control network element, such as the network element ID of the sensing control network element and the association ID of the target sensing task.

Optionally, the access-network device reports the sensing data to the sensing collection entity in a user plane mode. Exemplarily, the user plane mode includes sending a data packet carrying the sensing data to the sensing collection entity.

Step 608, the sensing collection entity generates the final sensing result corresponding to the target sensing task based on the sensing data related to the target sensing task.

Step 610, the sensing collection entity sends first notification information to the sensing control network element, where the first notification information is used for notifying the sensing control network element that the final sensing result has been generated.

Optionally, the first notification information includes sensing result exposure information, where the sensing result exposure information is used for obtaining the final sensing result. Optionally, the sensing result exposure information includes at least one of:

an address for obtaining the final sensing result or authorization information for the final sensing result.

Step 612, the sensing control network element sends second notification information to the AF, where the second notification information is used for notifying the AF that the final sensing result has been generated, so that the AF obtains the final sensing result according to the second notification information.

Optionally, the second notification information includes the sensing result exposure information, such as the address for obtaining the final sensing result and the authorization information for the final sensing result.

After receiving the second notification information, the AF may obtain the final sensing result corresponding to the target sensing task in the user plane mode according to the sensing result exposure information in the second notification information.

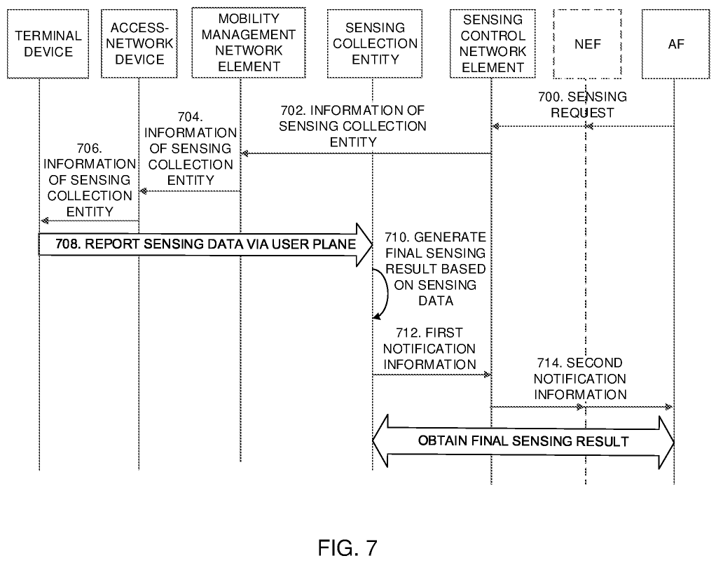

Referring to FIG. 7, FIG. 7 is a flowchart of a method for collecting sensing data provided in another embodiment of the disclosure. The method may be applied to the system architectures illustrated in FIG. 1 to FIG. 4 above. In the embodiments, a sensing control network element provides information of a sensing collection entity to an access-network device via a mobility management network element, and then the access-network device provides the information to a terminal device, so that the terminal device reports sensing data related to a target sensing task to the sensing collection entity. An AF obtains a final sensing result corresponding to the target sensing task from the sensing collection entity. As illustrated in FIG. 7, the method may include at least one of the following steps (700˜714).

Step 700, a sensing control network element receives a sensing request sent by an AF, where the sensing request is used for requesting obtaining a final sensing result corresponding to a target sensing task.

Step 702, the sensing control network element sends information of a sensing collection entity to a mobility management network element.

Optionally, the sensing control network element sends a first sensing instruction to the mobility management network element, where the first sensing instruction contains the information of the sensing collection entity. For example, the information of the sensing collection entity includes at least one of: a network element ID of the sensing collection entity, an IP address of the sensing collection entity, or domain name information of the sensing collection entity.

Optionally, the first sensing instruction further contains information of the sensing control network element. For example, the information of the sensing control network element includes at least one of: a network element ID of the sensing control network element or an association ID of the target sensing task.

Step 704, the mobility management network element sends the information of the sensing collection entity to an access-network device.

Optionally, the mobility management network element sends a second sensing instruction to the access-network device, where the second sensing instruction contains the information of the sensing collection entity, and optionally further contains the information of the sensing control network element.

Step 706, the access-network device sends the information of the sensing collection entity to a terminal device.

Optionally, the access-network device sends a third sensing instruction to the terminal device, where the third sensing instruction contains the information of the sensing collection entity, and optionally further contains the information of the sensing control network element.

Optionally, the access-network device sends the third sensing instruction (at least containing the information of the sensing collection entity) to the terminal device through a radio resource control (RRC) message.

Step 708, the terminal device reports sensing data related to the target sensing task to the sensing collection entity according to the information of the sensing collection entity.

Optionally, the sensing data includes at least one of: sensing measurement data or a sensing result. Optionally, the sensing data further includes the information of the sensing control network element, such as the network element ID of the sensing control network element and the association ID of the target sensing task.

Optionally, the terminal device reports the sensing data to the sensing collection entity in a user plane mode. Exemplarily, the user plane mode includes sending a data packet carrying the sensing data to the sensing collection entity.

Step 710, the sensing collection entity generates the final sensing result corresponding to the target sensing task based on the sensing data related to the target sensing task.

Step 712, the sensing collection entity sends first notification information to the sensing control network element, where the first notification information is used for notifying the sensing control network element that the final sensing result has been generated.

Optionally, the first notification information includes sensing result exposure information, where the sensing result exposure information is used for obtaining the final sensing result. Optionally, the sensing result exposure information includes at least one of: an address for obtaining the final sensing result or authorization information for the final sensing result.

Step 714, the sensing control network element sends second notification information to the AF, where the second notification information is used for notifying the AF that the final sensing result has been generated, so that the AF obtains the final sensing result according to the second notification information.

Optionally, the second notification information includes the sensing result exposure information, such as the address for obtaining the final sensing result and the authorization information for the final sensing result.

After receiving the second notification information, the AF may obtain the final sensing result corresponding to the target sensing task in a user plane mode according to the sensing result exposure information in the second notification information.

Referring to FIG. 8, FIG. 8 is a flowchart of a method for collecting sensing data provided in another embodiment of the disclosure. The method may be applied to the system architectures illustrated in FIG. 1 to FIG. 4 above. In the embodiments, a sensing control network element provides information of a sensing collection entity to a mobility management network element, and then the mobility management network element provides the information to a terminal device, so that the terminal device reports sensing data related to a target sensing task to the sensing collection entity. An AF obtains a final sensing result corresponding to the target sensing task from the sensing collection entity. As illustrated in FIG. 8, the method may include at least one of the following steps (800˜812).

Step 800, a sensing control network element receives a sensing request sent by an AF, where the sensing request is used for requesting obtaining a final sensing result corresponding to a target sensing task.

Step 802, the sensing control network element sends information of a sensing collection entity to a mobility management network element.

Optionally, the sensing control network element sends a first sensing instruction to the mobility management network element, where the first sensing instruction contains the information of the sensing collection entity. For example, the information of the sensing collection entity includes at least one of: a network element ID of the sensing collection entity, an IP address of the sensing collection entity, or domain name information of the sensing collection entity.

Optionally, the first sensing instruction further contains information of the sensing control network element. For example, the information of the sensing control network element includes at least one of: a network element ID of the sensing control network element or an association ID of the target sensing task.

Step 804, the mobility management network element sends the information of the sensing collection entity to a terminal device.

Optionally, the mobility management network element sends a fourth sensing instruction to the terminal device, where the fourth sensing instruction contains the information of the sensing collection entity, and optionally further contains the information of the sensing control network element.

Optionally, the mobility management network element sends the fourth sensing instruction (at least containing the information of the sensing collection entity) directly to the terminal device through a NAS message.

Step 806, the terminal device reports sensing data related to the target sensing task to the sensing collection entity according to the information of the sensing collection entity.

Optionally, the sensing data includes at least one of: sensing measurement data or a sensing result. Optionally, the sensing data further includes the information of the sensing control network element, such as the network element ID of the sensing control network element and the association ID of the target sensing task.

Optionally, the terminal device reports the sensing data to the sensing collection entity in a user plane mode. Exemplarily, the user plane mode includes sending a data packet carrying the sensing data to the sensing collection entity.

Step 808, the sensing collection entity generates the final sensing result corresponding to the target sensing task based on the sensing data related to the target sensing task.

Step 810, the sensing collection entity sends first notification information to the sensing control network element, where the first notification information is used for notifying the sensing control network element that the final sensing result has been generated.

Optionally, the first notification information includes sensing result exposure information, where the sensing result exposure information is used for obtaining the final sensing result. Optionally, the sensing result exposure information includes at least one of: an address for obtaining the final sensing result or authorization information for the final sensing result.

Step 812, the sensing control network element sends second notification information to the AF, where the second notification information is used for notifying the AF that the final sensing result has been generated, so that the AF obtains the final sensing result according to the second notification information.

Optionally, the second notification information includes the sensing result exposure information, such as the address for obtaining the final sensing result and the authorization information for the final sensing result.

After receiving the second notification information, the AF may obtain the final sensing result corresponding to the target sensing task in the user plane mode according to the sensing result exposure information in the second notification information.

The technical solutions provided in the embodiments of the disclosure may have the following advantages.

Information of a core network element for collecting sensing data is provided to an access-network device and/or a terminal device. As such, after obtaining sensing data, the access-network device and/or the terminal device can report successfully to the core network element for collecting sensing data, thereby ensuring reliability and success rate of collecting and reporting the sensing data.

It should be noted that, in the foregoing embodiments, for the convenience of understanding, the technical solutions of the disclosure are described only from the perspective of interaction between multiple devices. The foregoing steps performed by the first core network element (such as a sensing control network element) may be implemented separately as a method for collecting sensing data at a first core network element side. The foregoing steps performed by the second core network element (such as a sensing collection entity) may be implemented separately as a method for collecting sensing data at second core network element side. The foregoing steps performed by the third core network element (such as a mobility management network element) may be implemented separately as a method for collecting sensing data at a third core network element side. The foregoing steps performed by the access-network device may be implemented separately as a method for collecting sensing data at an access-network device side. The foregoing steps performed by the terminal device may be implemented separately as a method for collecting sensing data at a terminal device side.

The following will describe apparatus embodiments of the disclosure, which may be used for implementing the method embodiments of the disclosure. For details not disclosed in the apparatus embodiments of the disclosure, reference can be made to the method embodiments of the disclosure.

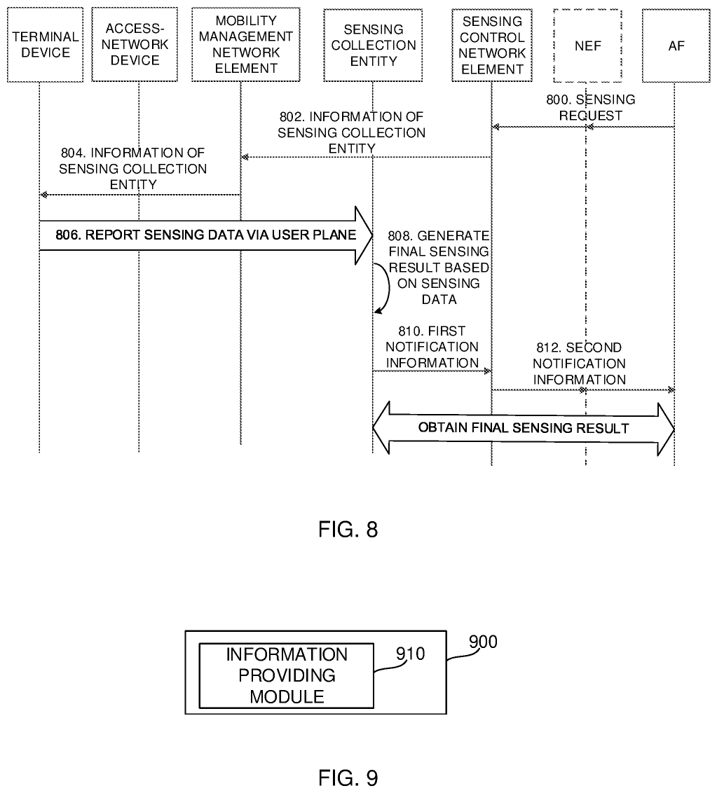

Referring to FIG. 9, FIG. 9 is a block diagram of an apparatus for collecting sensing data provided in an embodiment of the disclosure. The apparatus has a function of implementing method examples at a first core network element (such as a sensing control network element) side. The function may be implemented by hardware, or may be implemented by hardware executing corresponding software. The apparatus may be the first core network element described above, or may be disposed in the first core network element. As illustrated in FIG. 9, the apparatus 900 may include an information providing module 910. The information providing module 910 is configured to provide information of a second core network element to an access-network device and/or a terminal device, where the second core network element is a network element for collecting sensing data.

In some embodiments, the information of the second core network element includes at least one of: a network element ID of the second core network element, an IP address of the second core network element, or domain name information of the second core network element.

In some embodiments, the sensing data includes at least one of: sensing measurement data or a sensing result, where the sensing measurement data is data for determining the sensing result.

In some embodiments, the sensing data further includes information of the first core network element.

In some embodiments, the information providing module 910 is configured to:send the information of the second core network element to a third core network element, where the information of the second core network element is provided to the access-network device by the third core network element, and the sensing data is reported to the second core network element by the access-network device according to the information of the second core network element; and/or send the information of the second core network element to the third core network element, where the information of the second core network element is provided to the terminal device by the third core network element, and the sensing data is reported to the second core network element by the terminal device according to the information of the second core network element.

In some embodiments, the information providing module 910 is configured to send a sensing instruction to the third core network element, where the sensing instruction contains the information of the second core network element.

In some embodiments, the sensing instruction further contains the information of the first core network element.

In some embodiments, the apparatus 900 further includes a notification receiving module (not illustrated in FIG. 9). The notification receiving module is configured to receive first notification information from the second core network element, where the first notification information is used for notifying the first core network element that a final sensing result corresponding to a target sensing task has been generated.

In some embodiments, the apparatus 900 further includes a notification sending module (not illustrated in FIG. 9). The notification sending module is configured to send second notification information to an AF, where the second notification information is used for notifying the AF that the final sensing result has been generated, and for the AF to obtain the final sensing result according to the second notification information.

In some embodiments, the first notification information and/or the second notification information includes sensing result exposure information, where the sensing result exposure information is used for obtaining the final sensing result.

In some embodiments, the sensing result exposure information includes at least one of: an address for obtaining the final sensing result or authorization information for the final sensing result.

In some embodiments, the information of the first core network element includes at least one of: a network element ID of the first core network element or an association ID of the target sensing task.

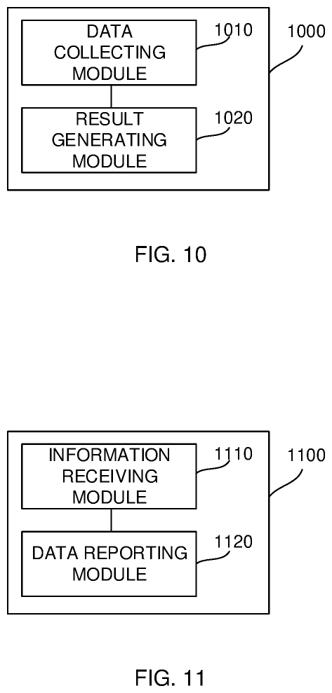

Referring to FIG. 10, FIG. 10 is a block diagram of an apparatus for collecting sensing data provided in another embodiment of the disclosure. The apparatus has a function of implementing method examples at a second core network element (such as a sensing collection entity) side. The function may be implemented by hardware, or may be implemented by hardware executing corresponding software. The apparatus may be the second core network element described above, or may be disposed in the second core network element. As illustrated in FIG. 10, the apparatus 1000 may include a data collecting module 1010 and a result generating module 1020. The data collecting module 1010 is configured to collect sensing data reported by an access-network device and/or a terminal device. The result generating module 1020 is configured to generate a final sensing result corresponding to a target sensing task based on the sensing data.

In some embodiments, the sensing data includes at least one of: sensing measurement data or a sensing result, where the sensing measurement data is data for determining the sensing result.

In some embodiments, the sensing data further includes information of a first core network element.

In some embodiments, the apparatus 1000 further includes a notification sending module (not illustrated in FIG. 10). The notification sending module is configured to send first notification information to the first core network element, where the first notification information is used for notifying the first core network element that the final sensing result has been generated.

In some embodiments, the notification sending module is further configured to determine the first core network element according to configuration information stored, or determine the first core network element according to the information of the first core network element in the sensing data.

In some embodiments, the first notification information includes sensing result exposure information, where the sensing result exposure information is used for obtaining the final sensing result.

In some embodiments, the sensing result exposure information includes at least one of: an address for obtaining the final sensing result or authorization information for the final sensing result.

In some embodiments, the information of the first core network element includes at least one of: a network element ID of the first core network element or an association ID of the target sensing task.

Referring to FIG. 11, FIG. 11 is a block diagram of an apparatus for collecting sensing data provided in another embodiment of the disclosure. The apparatus has a function of implementing method examples at an access-network device and/or terminal device side. The function may be implemented by hardware, or may be implemented by hardware executing corresponding software. The apparatus may be the access-network device and/or the terminal device described above, or may be disposed in the access-network device and/or the terminal device. As illustrated in FIG. 11, the apparatus 1100 may include an information receiving module 1110 and a data reporting module 1120. The information receiving module 1110 is configured to receive information of a second core network element provided by a first core network element. The data reporting module 1120 is configured to report sensing data to the second core network element according to the information of the second core network element.

In some embodiments, the information of the second core network element includes at least one of: a network element ID of the second core network element, an IP address of the second core network element, or domain name information of the second core network element.

In some embodiments, the data reporting module 1120 is configured to report the sensing data to the second core network element in a user plane mode according to the information of the second core network element.

In some embodiments, the user plane mode includes sending a data packet carrying the sensing data to the second core network element.

In some embodiments, the sensing data includes at least one of: sensing measurement data or a sensing result, where the sensing measurement data is data for determining the sensing result.

In some embodiments, the sensing data further includes information of the first core network element.

In some embodiments, the information of the first core network element includes at least one of: a network element ID of the first core network element or an association ID of a target sensing task.

In some embodiments, the information receiving module 1110 is configured to receive the information of the second core network element sent by a third core network element, where the information of the second core network element is sent to the third core network element by the first core network element.

In some embodiments, for an access-network device, the information receiving module 1110 is configured to receive the information of the second core network element from the third core network element. For a terminal device, the information receiving module 1110 is configured to: receive the information of the second core network element from the access-network device, where the information of the second core network element is sent to the access-network device by the third core network element; or receive the information of the second core network element from the third core network element.

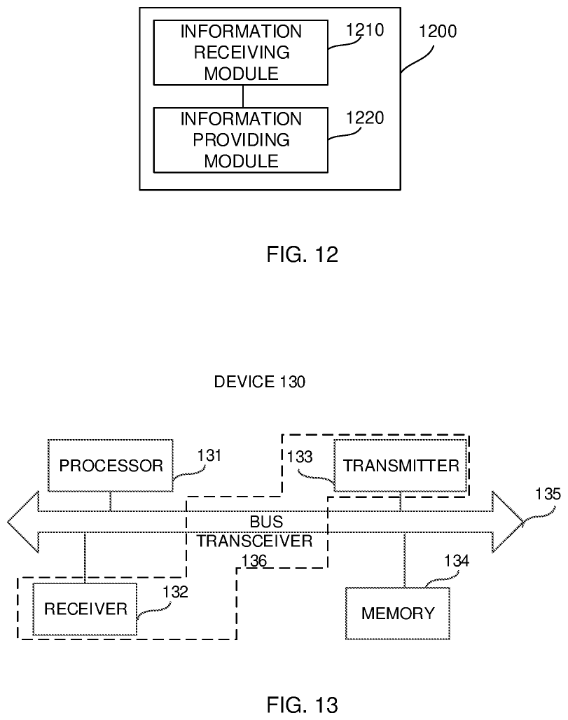

Referring to FIG. 12, FIG. 12 is a block diagram of an apparatus for collecting sensing data provided in another embodiment of the disclosure. The apparatus has a function of implementing method examples at a third core network element (such as a mobility management network element). The function may be implemented by hardware, or may be implemented by hardware executing corresponding software. The apparatus may be the third core network element described above, or may be disposed in the third core network element. As illustrated in FIG. 12, the apparatus 1200 may include an information receiving module 1210 and an information providing module 1220. The information receiving module 1210 is configured to receive information of a second core network element sent by a first core network element. The information providing module 1220 is configured to provide the information of the second core network element to an access-network device and/or a terminal device, where the second core network element is a network element for collecting sensing data.

In some embodiments, the information of the second core network element includes at least one of: a network element ID of the second core network element, an IP address of the second core network element, or domain name information of the second core network element.

In some embodiments, the sensing data includes at least one of: sensing measurement data or a sensing result, where the sensing measurement data is data for determining the sensing result.

In some embodiments, the sensing data further includes information of the first core network element.

In some embodiments, the information receiving module 1210 is configured to receive a sensing instruction sent by the first core network element, where the sensing instruction includes the information of the second core network element.

In some embodiments, the sensing instruction further contains the information of the first core network element.

In some embodiments, the information providing module 1220 is configured to:send the information of the second core network element to the access-network device, where the sensing data is reported to the second core network element by the access-network device according to the information of the second core network element; and/or send the information of the second core network element to the terminal device, where the sensing data is reported to the second core network element by the terminal device according to the information of the second core network element.

In some embodiments, the information providing module 1220 is configured to: send the information of the second core network element to the terminal device via the access-network device, or send the information of the second core network element directly to the terminal device.

In some embodiments, the information of the first core network element includes at least one of: a network element ID of the first core network element or an association ID of a target sensing task.

It should be noted that, when the apparatus provided in the foregoing embodiments implements functions of the apparatus, the division of various functional modules described above is taken as an example for illustration. In practice, the foregoing functions may be allocated to different functional modules for implementation according to actual requirements, that is, the structure of the device is divided into different functional modules to implement all or some of the foregoing functions.

With respect to the apparatus in the foregoing embodiments, the manner in which the modules perform the operations has been described in detail in the embodiments related to the method, and will not be described in detail again herein.

Referring to FIG. 13, FIG. 13 is a schematic structural diagram of a device 130 provided in an embodiment of the disclosure. The device 130 may include a processor 131, a receiver 132, a transmitter 133, a memory 134, and a bus 135.

The processor 131 includes one or more processing cores. The processor 131 is configured to execute various function applications and perform information processing by running software programs and modules.

The receiver 132 and transmitter 133 may be implemented as a transceiver 136, where the transceiver 136 may be a communication chip.

The memory 134 is connected to the processor 131 via the bus 135.

The memory 134 may be configured to store computer programs, and the processor 131 is configured to execute the computer programs to implement the foregoing method for collecting sensing data.

In addition, the memory 134 may be implemented by any type of volatile storage device or non-volatile storage device or a combination thereof. The volatile storage device or non-volatile storage device includes, but is not limited to, a random-access memory (RAM), a read-only memory (ROM), an erasable programmable ROM (EPROM), an electrically EPROM (EEPROM), a flash memory or other solid state storage devices, a compact disc ROM (CD-ROM), a digital video disc (DVD) or other optical storage, a magnetic cassette, a magnetic tape, magnetic disk storage, or other magnetic storage devices.

Specifically, when the device 130 is the first core network element described above, the processor 131 executes the computer programs stored in the memory 134 to implement the foregoing method for collecting sensing data at a first core network element side. When the device 130 is the second core network element described above, the processor 131 executes the computer programs stored in the memory 134 to implement the foregoing method for collecting sensing data at a second core network element side. When the device 130 is the third core network element described above, the processor 131 executes the computer programs stored in the memory 134 to implement the foregoing method for collecting sensing data at a third core network element side. When the device 130 is the access-network device described above, the processor 131 executes the computer programs stored in the memory 134 to implement the foregoing method for collecting sensing data at an access-network device side. When the device 130 is the terminal device described above, the processor 131 executes the computer programs stored in the memory 134 to implement the foregoing method for collecting sensing data at a terminal device side.

For details not elaborated in the embodiment, reference can be made to the foregoing embodiments, which will not be described in detail again herein.

Embodiments of the disclosure further provide a system for collecting sensing data. The system includes a first core network element, a second core network element, an access-network device and/or a terminal device, and a third core network element. The first core network element is configured to perform the foregoing method at a first core network element side. The second core network element is configured to perform the foregoing method at a second core network element side. The access-network device and/or the terminal device is configured to perform the foregoing method at an access-network device and/or terminal device side. The third core network element is configured to perform the foregoing method at a third core network element side.

Embodiments of the disclosure further provide a computer-readable storage medium. The storage medium is configured to store computer programs. The computer programs are configured to be executed by a processor to implement the foregoing method at a first core network element side, or the foregoing method at a second core network element side, or the foregoing method at an access-network device and/or target terminal device side, or the foregoing method at a third core network element side. Optionally, the computer-readable storage medium may include a ROM, a RAM, a solid state drive (SSD), or an optical disk. The RAM may include a resistance RAM (ReRAM) and a dynamic RAM (DRAM).

Embodiments of the disclosure further provide a chip. The chip includes a programmable logic circuit and/or program instructions. The chip is configured to, when running, implement the foregoing method at a first core network element side, or the foregoing method at a second core network element side, or the foregoing method at an access-network device and/or target terminal device side, or the foregoing method at a third core network element side.

Embodiments of the disclosure further provide a computer program product or a computer program. The computer program product or the computer program includes computer instructions. The computer instructions are stored in a computer-readable storage medium and configured to be read and executed by a processor, so as to implement the foregoing method at a first core network element side, or the foregoing method at a second core network element side, or the foregoing method at an access-network device and/or target terminal device side, or the foregoing method at a third core network element side.

It should be understood that, “indication” referred to in embodiments of the disclosure may be a direct indication, may be an indirect indication, or may mean that there is an association. For example, A indicates B may mean that A directly indicates B, for instance, B can be obtained according to A; may mean that A indirectly indicates B, for instance, A indicates C, and B can be obtained according to C; or may mean that that there is an association between A and B.

In the elaborations of embodiments of the disclosure, the term “correspondence” may mean that there is a direct or indirect correspondence between the two, may mean that there is an association between the two, or may mean a relationship of indicating and indicated or configuring and configured, etc.

In some embodiments of the disclosure, the “pre-defined” can be implemented by pre-saving a corresponding code or table in a device (for example, including the terminal device and the network device) or in other manners that can be used for indicating related information, and the disclosure is not limited in this regard. For example, the “pre-defined” may mean defined in a protocol.

In some embodiments of the disclosure, the “protocol” may refer to a communication standard protocol, which may include, for example, an LTE protocol, an NR protocol, and a protocol applied to a future communication system, and the disclosure is not limited in this regard.

The “multiple” referred to herein refers to two or more than two. The “and/or” describes an association between associated objects, which means that there may be three relationships. For example, A and/or B may mean A alone, both A and B exist, and B alone. The character “/” generally indicates that the associated objects are in an “or” relationship.

In addition, the serial numbers of the steps described herein merely exemplarily illustrate a possible execution order between the steps. In some other embodiments, the foregoing steps may not be executed according to the order of the serial numbers, for example, two steps with different serial numbers are performed simultaneously, or two steps with different serial numbers are performed in an order opposite to that illustrated in the figure, and embodiments of the disclosure are not limited in this regard.

Those skilled in the art should appreciate that, in one or more of the foregoing examples, the functions described in the embodiments of the disclosure may be implemented by hardware, software, firmware, or any combination thereof. When implemented by software, the functions may be stored in a computer-readable medium or transmitted as one or more instructions or codes on a computer-readable medium. The computer-readable medium includes a computer storage medium and a communication medium, where the communication medium includes any medium that facilitates transfer of computer programs from one place to another, and the storage medium may be any usable medium that can be accessed by a general purpose computer or a special purpose computer.

The foregoing elaborations are merely exemplary embodiments of the disclosure, but are not intended to limit the disclosure. Any modification, equivalent replacement, and improvement made within the spirit and principle of the disclosure shall belong to the protection scope of the disclosure.

I/we claim:

1. A method for collecting sensing data, being performed by an access-network device or a terminal device and comprising:
receiving information of a second core network element provided by a first core network element; and
reporting sensing data to the second core network element according to the information of the second core network element.

2. The method of claim 1, wherein the information of the second core network element comprises at least one of: a network element identity (ID) of the second core network element, an internet protocol (IP) address of the second core network element, or domain name information of the second core network element.

3. The method of claim 1, wherein reporting the sensing data to the second core network element according to the information of the second core network element comprises:
reporting the sensing data to the second core network element through a user plane according to the information of the second core network element.

4. The method of claim 3, wherein reporting the sensing data to the second core network element through the user plane comprises: sending a data packet carrying the sensing data to the second core network element through the user plane.

5. The method of claim 1, wherein the sensing data comprises at least one of: sensing measurement data or a sensing result, wherein the sensing measurement data is data for determining the sensing result.

6. The method of claim 5, wherein the sensing data further comprises information of the first core network element.

7. The method of claim 6, wherein the information of the first core network element comprises at least one of: a network element ID of the first core network element or an association ID of a target sensing task.

8. An apparatus for collecting sensing data, being an access-network device or a terminal device and comprising:
a transceiver;
a memory configured to store computer programs; and
a processor coupled to the transceiver and configured to execute the computer programs stored in the memory to cause the transceiver to:
receive information of a second core network element provided by a first core network element; and
report sensing data to the second core network element according to the information of the second core network element.

9. The apparatus of claim 8, wherein the information of the second core network element comprises at least one of: a network element identity (ID) of the second core network element, an internet protocol (IP) address of the second core network element, or domain name information of the second core network element.

10. The apparatus of claim 8, wherein the transceiver configured to report the sensing data to the second core network element according to the information of the second core network element is configured to:
report the sensing data to the second core network element through a user plane according to the information of the second core network element.

11. The apparatus of claim 10, wherein the transceiver configured to report the sensing data to the second core network element through the user plane is configured to:
send a data packet carrying the sensing data to the second core network element through the user plane.

12. The apparatus of claim 8, wherein the sensing data comprises at least one of: sensing measurement data or a sensing result, wherein the sensing measurement data is data for determining the sensing result.

13. The apparatus of claim 12, wherein the sensing data further comprises information of the first core network element. 14 The apparatus of claim 13, wherein the information of the first core network element comprises at least one of: a network element ID of the first core network element or an association ID of a target sensing task.

15. A core network element, comprising
a transceiver;
a memory configured to store computer programs; and
a processor coupled to the transceiver and configured to execute the computer programs stored in the memory to cause the transceiver to:
receive sensing data from an access-network device or a terminal device, wherein the sensing data is sent by the access-network device or the terminal device according to information of the core network element provided by a first core network element.

16. The core network element of claim 15, wherein the information of the second core network element comprises at least one of: a network element identity (ID) of the second core network element, an internet protocol (IP) address of the second core network element, or domain name information of the second core network element.

17. The core network element of claim 15, wherein the transceiver configured to receive the sensing data is configured to:
receive the sensing data that is sent through a user plane according to the information of the second core network element.

18. The core network element of claim 17, wherein the transceiver configured to receive the sensing data that is sent through the user plane is configured to:
receive a data packet carrying the sensing data that is sent through the user plane.

19. The core network element of claim 15, wherein the sensing data comprises at least one of: sensing measurement data or a sensing result, wherein the sensing measurement data is data for determining the sensing result.

20. The core network element of claim 19, wherein the sensing data further comprises information of the first core network element.
